(19) United States
(12) Patent Application Publication
(10) Pub. No.: US 2007/0112752 A1
(43) Pub. Date: May 17, 2007

(54) Combination of matching strategies under consideration of data quality

(76) Inventors: Wolfgang Kalthoff, Bad Schoenborn (DE); Jens Staeck, Sandhausen (DE); Karl Fuerst, Wiesloch (DE); Volker Schott, Nussloch (DE); Peter Lang, Bad Schoenborn (DE); Manfred Walter, Schwetzingen (DE)

Correspondence Address: FISH & RICHARDSON, P.C., PO BOX 1022, MINNEAPOLIS, MN, 55440-1022, US

(21) Appl. No.: 11/273,598

(22) Filed: Nov. 14, 2005

(51) Int. Cl. G06F 17/30

(52) U.S. Cl. 707/5

(57) ABSTRACT

Systems and techniques for characterizing a similarity between first and second data objects are described. A system includes a matching engine configured to receive first and second results provided by first and second attribute-matching strategies. The matching engine is further configured to scale the first result by a first weight factor that indicates a first level of quality of a first attribute value and to scale the second result by a second weight factor that indicates a second level of quality of a second attribute value. The matching engine is further configured to combine the first and second scaled results to produce an overall result characterizing the similarity between the first and second objects.

### TECHNICAL FIELD

This invention relates to building matching strategies for comparing data objects.

### BACKGROUND

Enterprise computer systems, such as, for example, an SAP® enterprise system available from SAP AG, of Walldorf, Germany, usually include and process data objects that include business objects. Business objects are data objects that relate to some business process of an enterprise. Business objects can represent, for example, material master records, equipment, business partners, and so forth.

Generally, a business object includes attributes, which can form a significant part of the content of the business object. An attribute can be named and can include values. For example, an attribute named business partner can include a text string value “SAP AG”. Attribute values can also include numeric values, as well as any other type of data, such as word strings, that can be generally incorporated into a data object. Business objects can be of different types, with each type relating to some particular business process. A material master, for example, is one type of business object. A business partner, such as, for example, a supplier, is another example of a particular type of business object.

Sometimes a computer system includes two or more data objects that refer to the same data set. For example, two person data objects, may refer to the same person. Data objects that refer to the same data are said to be “duplicate” data objects. It is often desirable to delete one or more duplicate data objects or to merge them so that only one unique data object is stored in the system. Conventionally this has been done by comparing an attribute of a data object (e.g., a name of first business partner object) with a corresponding attribute of another data object (e.g., a name of second business partner object). If the attributes match, these objects are found to be identical (and can be further processed by merging them or deleting all but one).

The attributes of duplicate data objects may or may not all be identical. For example, some of the attributes in either of the duplicate data objects may be missing data. Therefore, even if two data objects are indeed duplicates, a test that compares attribute value that is missing in either one or both of the data objects may incorrectly characterize the data objects as being non-duplicate.

### SUMMARY

The invention provides systems and methods, including computer program products, for characterizing a similarity between first and second data objects.

In general, in one aspect, the invention features a system that includes a matching engine configured to receive first and second results from first and second attribute-matching strategies. The first and second attribute-matching strategies compare both the first and second data objects with respect to first and second attributes, and as a result of the comparison, provide the first and second results describing a similarity between the first and second objects with respect to the first and second attributes. The matching engine is further configured to scale the first result by a first weight factor that indicates a first level of quality of a first attribute value, associated with the first attribute of the first and second data objects, to produce a first scaled result. The matching engine is further configured to scale the second result by a second weight factor that indicates a second level of quality of a second attribute value, associated with the second attribute of the first and second data objects, to produce a second scaled result. The matching engine is further configured to combine the first and second scaled results to produce an overall result characterizing the similarity between the first and second objects, which it may then present to a user in a report.

In general, in another aspect, the invention features a method and a computer program product for characterizing a similarity between first and second data objects. First and second results are received from first and second attribute-matching strategies that compare both the first and second data objects with respect to first and second attributes, and as a result of the comparison, provide the first and second results describing a similarity between the first and second objects with respect to the first and second attributes. The first result is scaled by a first weight factor that indicates a first level of quality of a first attribute value, associated with the first attribute of the first and second data objects, to produce a first scaled result. A second result is scaled by a second weight factor that indicates a second level of quality of a second attribute value, associated with the second attribute of the first and second data objects, to produce a second scaled result. The first and second scaled results are then combined (e.g. as a weighted average) to produce an overall result characterizing the similarity between the first and second objects.

Embodiments may include one or more of the following. The first weight factor equates to zero if the first level of quality is zero and the second weight factor equates to zero if the second level of quality is zero. Furthermore, the first level of quality may be selected to equate to zero if the first attribute value is missing from at least one of the first and second data objects, and the second level of quality may be selected to equate to zero if the second attribute value is missing from at least one of the first and second data objects. Instead of setting weighting factors to zero, the weight factor could be a minimum function that equates to the minimum of the first and second levels of quality. The first and second levels of quality may be independent. The first and second weight factors may be based on first and second business-relevance factors that indicate a relevance of the first and second attribute-matching strategies with respect to each other. A user interface may be provided to enable a user to determine at least one of: the first and second business-relevance factors, first and second rules for determining the first and second results of the attribute-matching strategies, and first and second rules for determining the first and second levels of quality. The first and second data objects may be stored in an objects database. In a repository, multiple attribute-matching strategies that include the first and second attribute-matching strategies may be stored along with a first set of rules for determining the first and second results of the first and second attribute-matching strategies and with a second set of rules for determining the first and second quality levels. The first and second sets of rules may include, for example, if-then statements, mathematical expressions, or a combination thereof.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a data management system;

FIG. 2 shows an exemplary repository of attribute-matching strategies for use with the data management system shown in FIG. 1;

FIG. 3 shows an exemplary indexed database for use with the data management system shown in FIG. 1;

FIG. 4 shows a flowchart of a process for building a comprehensive matching strategy; and

FIG. 5 shows a block diagram of a computer for implementing the steps of the process shown in FIG. 4.

### DETAILED DESCRIPTION

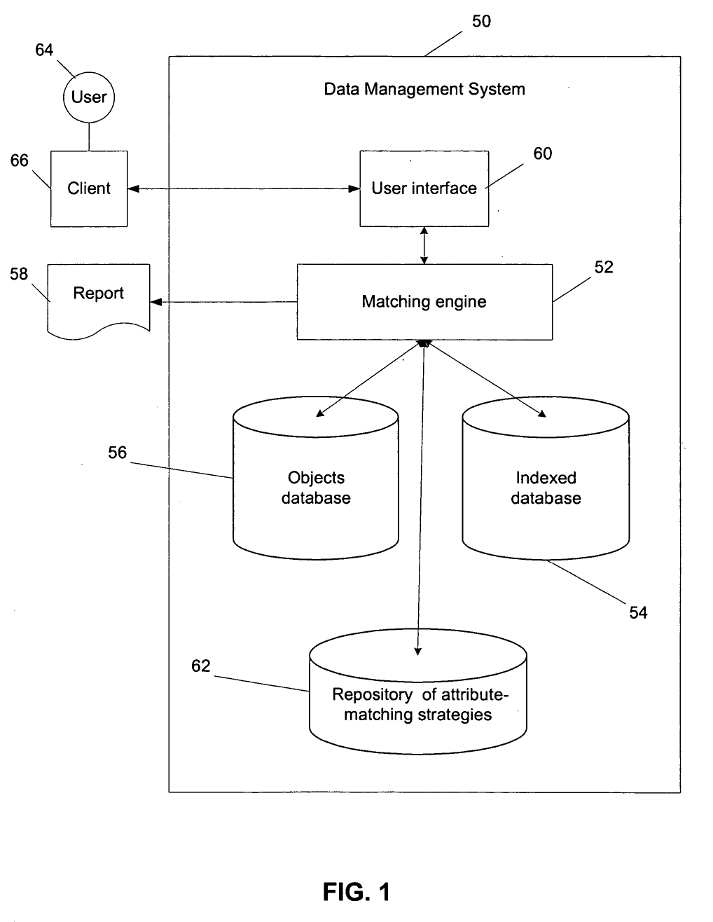

FIG. 1 shows an exemplary data management system 50, in which two or more data objects are compared according to a comprehensive matching strategy to provide an overall measurement of the similarity between the data objects. The results of the matching strategy are presented in a report 58 that may be analyzed by a user 64 (e.g., an administrator) or a computational process to determine whether or not the data objects are duplicates of each other and which, if any, duplicate data objects should be deleted from the objects data base 56.

The data management system 50 includes a matching engine 52, an objects database 56, a repository of attribute-matching strategies 62, an indexed data base 54, and a user interface 60 through which a user 64 at a client 66 interacts with the system 50. The system 50 could be a component of a service platform that integrates multiple business applications. The data management system 50 maintains and distributes data to the various business applications.

The management system 50 consolidates the data in the objects database 56, which could include, by way of example, multiple databases that can be located within the data management system 50 or distributed between multiple systems. The data includes data objects that are generally elements for information storage in computing systems. One example of a data object is a business object, which is typically used in data processing to describe the characteristics of an item or a process related to the operations of an enterprise. A business object can represent, by way of example, a business partner, a document, a sales order, a product, a piece of manufacturing equipment, an employee, and even the enterprise itself. Data objects can describe the characteristics of an item using a series of data fields that correspond to characteristics of the data objects, also referred to as “attributes”. Examples of attributes include an address, a DUNS number, a name, and a social security number. An attribute includes an entry that contains a value, referred to as “attribute value” that corresponds to the attribute. For example, a name attribute may be associated with attribute value composed of the text string “SAP AG”. The attribute value can be of a particular data type. Examples of data types include but are not limited to an alphanumeric string, an integer, and a floating point decimal number.

The comprehensive matching strategy is an algorithm that compares two objects and gives ranking number as a result that describes similarity of the objects. The matching engine 52 builds the comprehensive matching strategy from several simple attribute-matching strategies that each compare the two data objects with respect to one or more particular attribute(s); and as a result of the comparison, provides a value describing the similarity of the objects with respect to the one or more particular attribute(s). According to the comprehensive matching strategy specified for the data objects, the matching engine 52 aggregates the results from the attribute-matching strategies to obtain an overall result (i.e., an overall measurement of similarity between the data objects). For example, the overall result could be a percentage on a scale of zero to 100% in which zero represents no similarity between the data objects and 100% represents a perfect match.

When aggregating the results of individual attribute-matching strategies, the comprehensive matching strategy considers the importance of each attribute-matching strategy relative to the other attribute-matching strategies given the business relevance of that strategy and the quality of attribute value that is being compared. The importance of an attribute-matching strategy is quantified as a value referred to as a “weight factor.” When aggregating the results from the attribute-matching strategies, the matching engine 52 scales the results by their corresponding weight factors so that the results that are assigned the highest weight factors contribute the most to the overall result. For example, the overall result of the comprehensive matching strategy, rₒ, may be expressed by the following:

$${r}_{o} = ( {\sum }_{i = 1}^{N} {W}_{i} {r}_{i} ) / ( {\sum }_{i = 1}^{N} {W}_{i} ) , \qquad Equation 1$$

where, N is the total number of aggregated attribute-matching strategies, i is an index equal to a number between 1 and N, rᵢ represents the result of an aggregated attribute-matching strategy Sᵢ, and Wᵢ is the weight factor assigned to the matching strategy Siᵢ. The overall result rₒ ranges between “zero” and “one”, where zero represents no similarity between the compared data objects and one represents a perfect match.

Each attribute-matching strategy Sᵢ include rules for determining the result rᵢ. In the simplest case, the result rᵢ holds a value of either “zero” or “one”, where “one” indicates that the attributes are the same and “zero” indicates that the attributes are not the same.

In some embodiments, rᵢ holds a value that ranges between “zero” and “one”. For example, rᵢ could be a value between “zero” and “one” if attribute-matching strategy Sᵢ determines that a portion of the compared attributes are the same. The result of a matching strategy could be “zero” for one of two reasons: the first being that the attribute value for both objects is accurate but dissimilar and the second being that the attribute value for one or both objects is inaccurate and/or missing. If the result rᵢ is “zero” for the second reason, then no conclusive determination of similarity between the objects based on the attribute can be made. For example, two data objects may refer to the same object (e.g., a company); however, if the either or both of the data objects is missing data for a particular attribute (e.g., an address of company headquarters) or if the data was not entered accurately, a measurement of similarity between the two data objects based on a comparison of the attribute will be “zero” or approximately “zero”, when in fact the data objects are the same.

The weight factor assigned to an attribute-matching strategy determines how much an individual result of that attribute-matching strategy will contribute to the overall result. In the simplest scenario, the weight factors Wᵢ of equation 1 are all equal to “one”. In this scenario, the overall result would not take into consideration the importance of each attribute-matching strategy relative to other attribute-matching strategies. The weight factor is based on the business relevance of the matching strategy and the overall quality of the attribute value being compared by the attribute-matching strategy.

The business relevance of an attribute-matching strategy, which is quantified as “business-relevance factor”, indicates the importance of the attribute-matching strategy relative to other attribute-matching strategies. In some cases, importance may refer to the reliability of a positive match. For example, a result returned by an attribute-matching strategy that compares an attribute that is unique to each object, such as a DUNS number, may be considered twice as important as a result returned by another attribute-matching strategy that compares an attribute that may not be unique, such as a name. In some cases, the business relevance factor may represent a perceived accuracy of the data or reflect a probability that the data is accurate. For example, the business-relevance factor may depend on method of data entry (electronic versus manual entry). The business-relevance factor may also be based on the quality of the algorithm used by the attribute-matching strategy to compare the attribute value. For example, a result obtained by a fuzzy algorithm that can handle misspelling errors may be considered more conclusive than a result obtained by an algorithm that only matches exact text. Therefore, a higher business-relevance factor may be assigned to the attribute-matching strategy that uses the fuzzy algorithm. Any number of criteria may be used to determine the business-relevance factor of an attribute-matching strategy.

The weight factor also depends on quality factors determined for the data objects with respect to each attribute-matching strategy. A quality factor of a data object indicates a degree to which attribute value of a particular attribute is present or missing in the data object. In the simplest example, the quality factor is equal to “zero” if the attribute value is missing from the data object and is equal to “one” if the attribute value is present in the data object. In some embodiments, the quality factor is equal to a value between “one” and “zero” if a portion of the attribute value is present in the data object. For example, a quality factor of “0.5” could be assigned to an object of a name matching strategy if its name-attribute value includes a last name but not a first name.

The weight factor Wᵢ of a given matching strategy Sᵢ can be expressed as a mathematical function of the business relevance factor, denoted Bᵢ, and the quality factors determined for each of the business objects that are being compared. The quality factors with respect to first and second business objects A and B are denoted Qᵢ(A) and Qᵢ(B), respectively. The quality factors Qᵢ(A)and Qᵢ(B) are independent of each other. One possible expression for the weight factor Wᵢ is:
Wᵢ(A,B)=BᵢQᵢ(A)Qᵢ(B) Equation 2

The product of the quality factors ensures that if either Qᵢ(A) or Qᵢ(B) is “zero”, the resulting weight factor will be equal to “zero”. The weight factor Wᵢ could encompass other expressions, besides that shown in Equation 2, that equate to “zero” if one of the quality factors is “zero”. For example, the weight factor could be proportional to the square of the product of quality factors Qᵢ(A) and Qᵢ(B). In another example, the weight factor could be proportional to a function that calculates the minimum of the quality factors.

Because the weight factor equates to “zero” if either or both of the quality factors are “zero”, the comprehensive matching strategy correctly interprets whether a low- or zero-valued result of an attribute-matching strategy indeed reflects dissimilarity of the attribute value in each of the objects or if the result is caused by the absence of attribute value in either one or both of the objects. Furthermore, the business relevance of the attribute-matching strategy might be very high; however, if the attribute value is missing or compromised the comprehensive matching strategy will not consider that data in the overall comparison. By aggregating the individual results of multiple attribute-matching strategies that are scaled appropriately by corresponding weight factors, the comprehensive matching strategy increases the probability of accurately identifying duplicate objects.

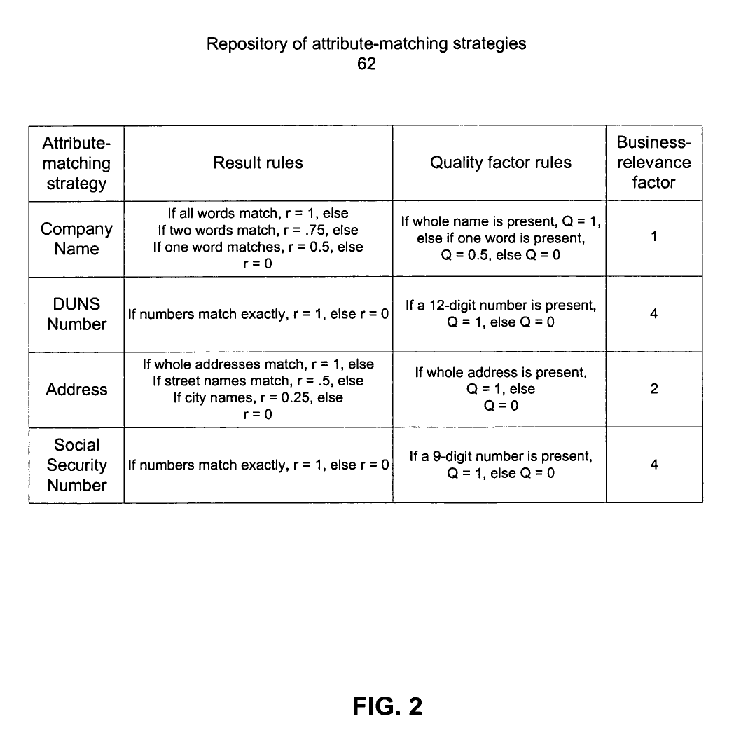

All attribute-matching strategies that could potentially be incorporated into a comprehensive matching strategy are stored in the repository of attribute-matching strategies 62. An example of the repository 62 is shown in FIG. 2. The repository 62 includes the names of the attribute-matching strategies, which in this case, are the same as the names of the attributes that the attribute-matching strategies compare. In some embodiments, the repository 62 includes separate columns for the names of the attribute-matching strategies and for the names of the attributes.

The repository 62 stores rules for determining the results of the attribute-matching strategies. The rules may include, for example, if-then statements, mathematical statements, or a combination thereof. For example, the result rules assigned for the attribute-matching strategy named “Company Name ” state that if all of the word strings of a first company-name attribute match all of the word strings of a second company-name attribute, the attribute-matching strategy will return a result of “1”. However, if only two of the words match but not all of the words match, the attribute-matching strategy will return a result of “0.75”. Likewise, if only one word matches but not all of the words match, the attribute-matching strategy will return a result of “0.5”. Finally if none of the words match, attribute-matching strategy will return a result of “0”.

The repository 62 also includes rules for calculating the quality factor of objects with respect to a particular attribute-matching strategy. The rules may include, for example, if-then statements, mathematical statements, or a combination thereof. For example, the quality factor rules assigned for the attribute-matching strategy named “Company Name” state that if a whole name is present in the company-name attribute of an object, the quality factor assigned to that object with respect to the “Company Name” attribute-matching strategy will be a value of “1”. However, if the name is incomplete but at least one word is included, the quality factor will have a value of “0.5”. However, if the company name attribute value is missing, the quality factor will be “zero”. In another example, the quality factor rules assigned to the “DUNS number” attribute specifies that if a 12-digit number is present in the corresponding attribute of a data object, the quality factor for that data object with respect to the DUNS number will be a value of “1”, otherwise the quality factor will be equal to “zero”. In some embodiments, a user can access the rules stored in the repository 62 through a user-interface 60 provided by the data management module 50. Using the user-interface 60, a user 64 may specify the rules for determining the result and quality factor for a given attribute-matching strategy. For exampled, the rules may be modified according to the needs of different business applications.

The repository 62 also stores business-relevance factors that correspond to the matching strategies. In the example shown in FIG. 2, the business-relevance factors corresponding to the “DUNS number” and the “Social Security Number” matching strategies are twice as large the business-relevance factor corresponding to the “Address” matching strategy and four times as large as the business-relevance factor corresponding to the “Company Name” matching strategy.

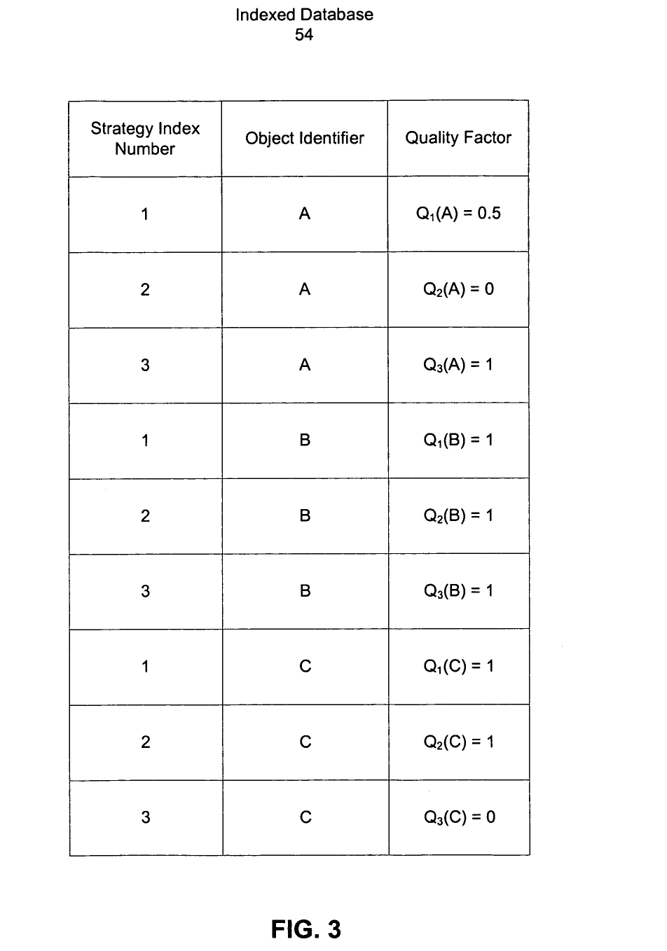

Referring to FIG. 3, an example of the indexed database 54 is shown. Using the user-interface 60, the user 64 may specify which attribute-matching strategies to aggregate into a comprehensive matching strategy. The indexed database 54 stores the index numbers of the selected attribute-matching strategies to be aggregated. For example, the attribute-matching strategies that have been selected could be the ones that compare company-name, DUNS-number, and address attributes. The indexed database 54 also stores the object identifiers of the objects to be compared by the attribute-matching strategies and their corresponding quality factors. The quality factors are calculated when the data for the objects is entered in the system or when it is changed and can be retrieved when the attribute-matching matching strategies are executed. The indexed database 54 enables the matching engine 52 to reduce runtime when building a comprehensive matching strategy by reusing the quality factors once they are calculated.

In one example, there are 1000 objects in the database that should be checked for duplicates and there are 5 attribute-matching strategies. In this example, the matching engine 52 would calculate 5*1000 quality factors and store them in the indexed database 54 (if they are not yet there). Then the matching engine 52 could then later calculate the 5*1000*1000 results of the object comparison rᵢ(A,B) for an attribute-matching strategy. These results are generally not stored because of the huge data volume.

Afterwards, if a new object is be entered in the system 50, a user 64 may want to check if there is already a similar object. In this case, the quality factors of the 1000 objects are already stored in the indexed database 54; therefore, it is sufficient to calculate 5 quality factors for the new object and 5*1000 results of object comparisons.

In some embodiments, a user 64 can access the data objects stored in the indexed database 54 through a user-interface 60 provided by the data management module 50. Using the user-interface 60, a user 64 may also access the repository 62. For example, the user 64 may specify the business-relevance factor of an attribute matching strategy and the rules for calculating a result. In some embodiments, the user 64 may specify an expression for calculating the weight factors. In these embodiments, the user interface 60 may present user 64 with a list of available attribute-matching strategies and weight factor expressions to choose from.

The matching engine 52 provides the overall result returned by the comprehensive matching strategy in a report 58. The report 58 may be provided to a user via the user interface 60 or by other means (e.g., mail, electronic-mail, or paper copy). By analyzing the report 58, the user 64 can determine whether the data objects are duplicates and decide which, if any, of the data objects to delete from the objects database 56 or to merge them. In some embodiments, the report 58 may be provided to a module that determines whether the objects are duplicates and deletes the appropriate duplicate data objects or merges them. In these embodiments, the module may be the matching engine 52, itself; a module within the data management module 50; or a module that is external to the data management module 50.

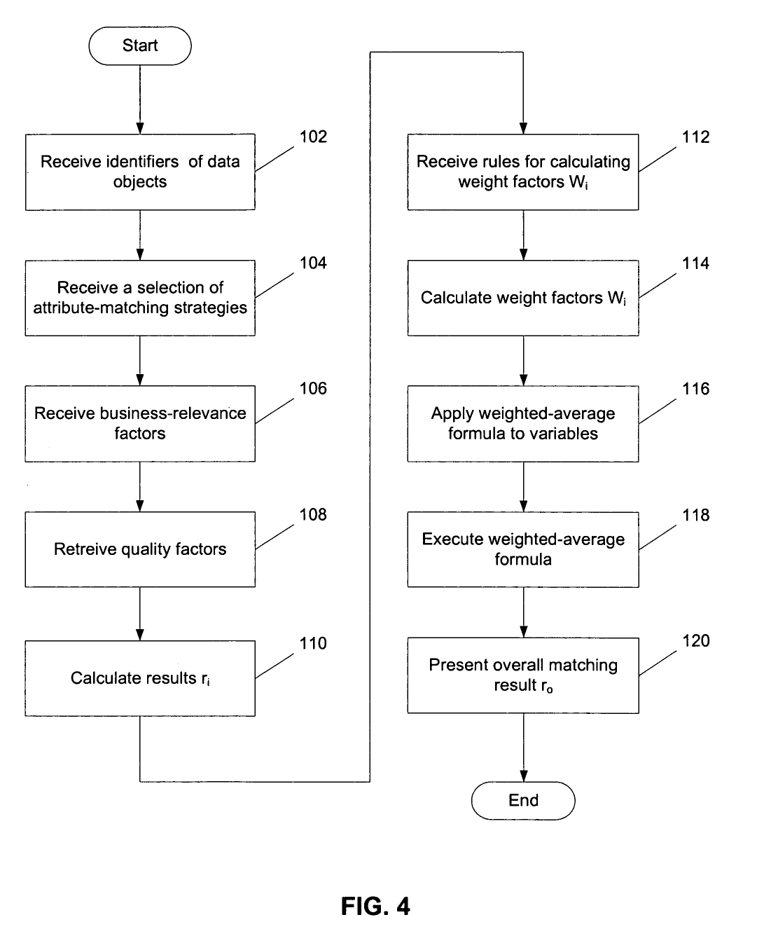

FIG. 4 shows a flowchart of a process 100 by which the matching engine builds a comprehensive matching strategy from multiple attribute-matching strategies. The matching engine 52 receives (102) identifiers (e.g., names) of data objects that have been selected to be compared (referred to as data objects A and B). The matching engine 52 receives (104) a selection of attribute-matching strategies that are to be combined into a comprehensive matching strategy and stores these in the indexed database 54. The matching engine 52 receives (106) a business-relevance factor assigned to each of the attribute-matching strategies that have been selected and stores the factors in the repository 62 such that they are referenced to their corresponding attribute-matching strategies. For each of the data objects and each of the attribute-matching strategies, the matching engine 52 retrieves (108) the corresponding quality factor stored in the indexed database 54. When calculating the quality factors with respect to a particular attribute-matching strategy, the matching engine 52 applies the rules for defining the quality factors that are stored with respect to the attribute-matching strategy in the matching strategy index 62. Using the rules supplied in the attribute-matching-strategy repository for determining matching results, the matching engine 52 calculates (110) the results rᵢ for each attribute-matching strategy and stores these values in memory. For example, the results might be stored in the indexed database 54. The results rᵢ are referenced to their corresponding attribute-matching strategies. The matching engine 52 receives (112) rules for calculating the weight factors for each of the matching strategies. The rules may, for example, specify a specific mathematical formula for calculating the weight factors. An example of such a mathematical formula is described above in Equation 2. In some embodiments, the rules are selected by a user that interacts with the data management module 50 through the user interface 60. The matching engine then applies the received rules to calculate (114) the weight factors Wᵢ corresponding to each of the attribute-matching strategies Sᵢ. The weight factors Wᵢ are stored in the indexed database 54 referenced to their corresponding attribute-matching strategies. The matching engine 52 applies (116) a weighted-average formula, such as that shown in Equation 1, to the weight factors Wᵢ and to the results rᵢ. In some embodiments, the weighted-average formula applied by the matching engine 52 is not limited to the formula shown in Equation 1 and can included other types of weighted-average formulas. The matching engine 52 executes the formula (118) to produce an overall matching result rₒ. The matching engine 52 may then present (120) the overall result rₒ in a report 58 that can be analyzed by a user 64 and/or by subsequent processes.

In some embodiments matching engine 52 encompasses one or more processors integrated into a computer. In other embodiments, the matching engine is a computer.

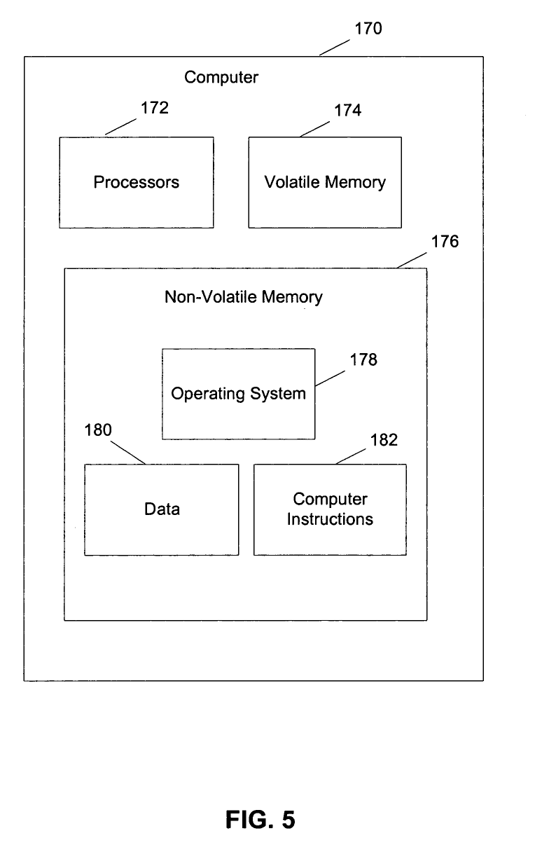

FIG. 5 shows a block diagram of a computer 170 for implementing the steps of the process 100 shown in FIG. 4. The computer 170 includes one or more processors 172, a volatile memory 174, and a non-volatile memory 176 (e.g., hard disk). Non-volatile memory 176 stores operating system 178, data 180, and computer instructions 182 which are executed by processor 172 out of volatile memory 174 to perform process 100.

The processes described herein, including process 100, can be implemented in digital electronic circuitry, or in computer software, firmware, or hardware, including the structural means disclosed in this specification and structural equivalents thereof, or in combinations of them. The processes can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes described herein, including method steps, can be performed by one or more programmable processors executing one or more computer programs to perform functions of the processes by operating on input data and generating output. The processes can also be performed by, and apparatus of the processes can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The processes can be implemented in a computing system that includes a back end component (e.g., a data server), a middleware component (e.g., an application server), or a front end component (e.g., a client computer having a graphical user interface or a Web browser through which a user can interact with an implementation of the processes), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The foregoing are examples for illustration only and not to limit the alternatives in any way. The processes described herein can be performed in a different order and still achieve desirable results. Although the processes are described using cargo container transportation examples, the processes described herein can be used to generate e-seals using sensor network parameters in any number of environments.

The processor described herein may be used in a variety of situations. For example system 50 may be used to delete duplicate data entries. The processor may also be useful in verifying the accuracy of data objects and for searching a database of data objects.

Method steps associated with generating a comprehensive matching strategy can be rearranged and/or one or more such steps can be omitted to achieve the same results described herein. Elements of different embodiments described herein may be combined to form other embodiments not specifically set forth above.

In other embodiments, the data management system 50 can be part of SAP® offering running inside or outside an SAP® enterprise system as a standalone system. This standalone system can work with other enterprise system from other companies. In one example, the matching engine 52 (which performs process 100) can be installed locally in a computer and the enterprise system can be installed remotely at other location. The local computer can be a regular networked computer or special mini-computer, such as the Stargate® server from Intel®.

Other embodiments not specifically described herein are also within the scope of the following claims.

What is claimed is:

1. A system for characterizing a similarity between first and second data objects, the system comprising:
a matching engine configured to:
receive first and second results from first and second attribute-matching strategies that compare both the first and second data objects with respect to first and second attributes, and as a result of the comparison, provide the first and second results describing a similarity between the first and second objects with respect to the first and second attributes;
scale the first result by a first weight factor that indicates a first level of quality of a first attribute value, associated with the first attribute of the first and second data objects, to produce a first scaled result;
scale the second result by a second weight factor that indicates a second level of quality of a second attribute value, associated with the second attribute of the first and second data objects, to produce a second scaled result; and
combine the first and second scaled results to produce an overall result characterizing the similarity between the first and second objects.

2. The system of claim 1, wherein:
the first weight factor equates to zero if the first level of quality is zero; and
the second weight factor equates to zero if the second level of quality is zero.

3. The system of claim 1, wherein the first and second weight factors are based on first and second business-relevance factors that indicate a relevance of the first and second attribute-matching strategies with respect to each other.

4. The system of claim 3, further comprising a user interface coupled to the matching engine, wherein the user interface is comprised to enable a user to determine at least one of: the first and second business-relevance factors, first and second rules for determining the first and second results of the attribute-matching strategies, and first and second rules for determining the first and second levels of quality.

5. The system of claim 1, wherein the matching engine is further configured to present the overall result in a report to a user.

6. The system of claim 2, further comprising an objects database for storing the first and second data objects.

7. The system of claim 1, wherein:
the first level of quality equates to zero if the first attribute value is missing from at least one of the first and second data objects; and
the second level of quality equates to zero if the second attribute value is missing from at least one of the first and second data objects.

8. The system of claim 1, wherein the first and second levels of quality are independent.

9. The system of claim 1, further comprising a repository that stores:
multiple attribute-matching strategies comprising the first and second attribute-matching strategies;
a first set of rules corresponding to the first and second attribute-matching strategies for determining the first and second results; a
a second set of rules for determining the first and second quality levels, wherein the first and second sets of rules include at least one of: if-then statements and mathematical expressions.

10. A computer-implemented method for characterizing a similarity between first and second data objects, the method comprising:
receiving first and second results from first and second attribute-matching strategies that compare both the first and second data objects with respect to first and second attributes, and as a result of the comparison, provide the first and second results describing a similarity between the first and second objects with respect to the first and second attributes;
scaling the first result by a first weight factor that indicates a first level of quality of a first attribute value, associated with the first attribute of the first and second data objects, to produce a first scaled result;
scaling the second result by a second weight factor that indicates a second level of quality of a second attribute value, associated with the second attribute of the first and second data objects, to produce a second scaled result; and
combining the first and second scaled results to produce an overall result characterizing the similarity between the first and second objects.

11. The method of claim 10, further comprising:
selecting the first weight factor to equate to zero if the first level of quality is zero; and
selecting the second weight factor to equate to zero if the second level of quality is zero.

12. The method of claim 10, further comprising basing the first and second weight factors on first and second business-relevance factors that indicate a relevance of the first and second attribute-matching strategies with respect to each other.

13. The method of claim 12, further comprising enabling a user to determine at least one of: the first and second business-relevance factors, first and second rules for determining the first and second results of the attribute-matching strategies, and first and second rules for determining the first and second levels of quality.

14. The method of claim 11, further comprising:
selecting the first level of quality to equate to zero if the first attribute value is missing from at least one of the first and second data objects;
selecting the second level of quality to equate to zero if the second attribute value is missing from at least one of the first and second data objects; and
selecting the first and second levels of quality to be independent.

15. The method of claim 1, wherein combining the first and second scaled results comprising determining a weighted average of the first and second scaled results.

16. A computer program product for characterizing a similarity between first and second data objects, the computer program product being tangibly stored on machine readable media, comprising instructions operable to cause one or more processors to:
receive first and second results from first and second attribute-matching strategies that compare both the first and second data objects with respect to first and second attributes, and as a result of the comparison, provide the first and second results describing a similarity between the first and second objects with respect to the first and second attributes;
scale the first result by a first weight factor that indicates a first level of quality of a first attribute value, associated with the first attribute of the first and second data objects, to produce a first scaled result;
scale the second result by a second weight factor that indicates a second level of quality of a second attribute value, associated with the second attribute of the first and second data objects, to produce a second scaled result; and
combine the first and second scaled results to produce an overall result characterizing the similarity between the first and second objects.

17. The product of claim 16, further comprising instructions to:
select the first weight factor to equate to zero if the first level of quality is zero; and
select the second weight factor to equate to zero if the second level of quality is zero.

18. The product of claim 16, further comprising instructions to base the first and second weight factors on first and second business-relevance factors that indicate a relevance of the first and second attribute-matching strategies with respect to each other.

19. The product of claim 17, further comprising instructions to:
select the first level of quality to equate to zero if the first attribute value is missing from at least one of the first and second data objects;
select the second level of quality to equate to zero if the second attribute value is missing from at least one of the first and second data objects; and
select the first and second levels of quality to be independent.

20. The product of claim 16, wherein the instructions operable to cause one or more processors to combine the first and second scaled results comprise instructions to determine a weighted average of the first and second scaled results.
